(19) United States
(12) Patent Application Publication
(10) Pub. No.: US 2001/0035129 A1
(43) Pub. Date: Nov. 1, 2001

(54) Metal grid lines on solar cells using plasma spraying techniques

(76) Inventors: Mohan Chandra, Merrimack, NH (US); Yuepeng Wan, Nashua, NH (US); Alleppey V. Hariharan, Nashua, NH (US); Jonathan A. Talbott, Amherst, NH (US)

Correspondence Address: MAINE & ASMUS, 100 MAIN STREET, P O BOX 3445, NASHUA, NH, 03061-3445, US

(21) Appl. No.: 09/802,072

(22) Filed: Mar. 8, 2001

Related U.S. Application Data
(60) Provisional application No. 60/187,635, filed on Mar. 8, 2000.
(60) Provisional application No. 60/249,122, filed on Nov. 16, 2000.

(51) Int. Cl. B05D 1/08

(52) U.S. Cl. 118/722; 427/446

(57) ABSTRACT

A method and apparatus for the production of solar cells by directly spraying metal powder for both lines and layers on the front and back sides of a silicon wafer using focused plasma spray technique for making contacts on solar cells.

This application relates and claims priority to pending U.S. applications Ser. No. 60/187635, filed Mar. 8, 2000, and Ser. No. 60/249122, filed Nov. 16, 2000.

### BACKGROUND OF THE INVENTION

1. Technical Field of the Invention

This invention relates to the application of metal onto both front and back surfaces of solar cells using thermal spray techniques to form the metal contacts; and more particularly to a metalization method by which a contact grid line of significant aspect ratio is formed directly on the face of a solar cell wafer by controlled movement of a focused plasma spray nozzle over the surface area of the wafer.

2. Background Art

Solar cells are effective devices for transferring solar energy directly into electricity. A typical prior art mono- or multi-grain silicon solar cell 1, as illustrated in FIGS. 1-3, contains fine contact grids 3 and bus bars 2 on the surface that faces sunlight. These metal contacts and bus bars are collection electrodes extending over the entire surface area for maximum capture and conduction of electrons produced on p/n junctions 5 by photovoltaic effects. Meanwhile, however, the total area covered by these collection electrodes should be minimum so that they do not block the sun-light that reaching the p/n junction layer 5 of the solar cell through the anti-reflective layer 4. Therefore, these metal contact grids are generally very thin lines; about 100 μm (microns). Typically the conduction grid on the front of the cell covers about 7-8% of the surface area.

As also shown in FIG. 2, the back side of the solar cell is covered by a layer of metal 6, usually aluminum, which is in direct contact with the doped base silicon wafer 7. This conductive layer 6 serves as the other electrode. It is usually connected to the front side of the next solar cell through a set of metal tabs that are soldered to several metal pads 8 on the surface of layer 6.

The fine contact grids 3 of FIG. 1 are commonly made by a screen printing method in which metal paste, usually silver paste, is printed on the surfaces of the solar cell through a patterned screen. After the desired pattern of contact grids are printed on the surface, the cell is subjected to a high temperature furnace, about 800° C., for drying of the silver paste and for penetrating of the contact metal into p/n junction layer 5.

The width and aspect ratio of a screen printed grid line is evident in FIG. 3; the line width W_{S} being typically in the range of 100 to 200 microns, the maximum height H_{S} being about 15 microns; the best aspect ratio of line height to width being only about ⅙ at best. These characteristics affect conductivity of the grid line and the efficiency of the solar cell.

Vacuum evaporation combined with photolithography is also used for the fabrication of the metal contacts 2, 3, 6 and 8. This method provides high quality metal contacts, however, it is expensive and is a relatively lengthy process, both of which detract from its suitability as a production method.

A metalization method utilizing plasma spray technique has also been proposed and explored by several other researchers, as described mainly in U.S. Pat. Nos. 4,297,391, 4,492,812, 4,320,251, 4,240,842 and 4,331,703. These publications have been dealing with the application of a plasma spray process in the metalization of solar cells, the metal materials appropriate for this purpose, ohmic contacts formed between the metal and p/n junctions, the direct spray deposition of the backside contact layer 6, metalization through an anti-reflective layer, and the use of masks for the desired pattern of contact grids.

What remains unresolved in the art of solar cell production is how to construct a metal grid line on the semiconductor wafer surface with a substantially higher aspect ratio than provided by screen printing methods. What remains unresolved in existing commercial applications of the plasma spray technique in the metalization of solar cells is how to make the front grid lines as thin as less than 100 μm. The proposed use of masks have technical problems with making a fine line with a width less than a millimeter. This is apparently a major obstruct hindering the commercial application of this technique.

### SUMMARY OF THE INVENTION

It is an object of this invention to provide a more efficient method of making ohmic contacts on solar cells. To this end there is disclosed a method and apparatus for the deposition of some or all metal contacts required on a solar cell by directly spraying metal powder using plasma spray technique for making the contact lines and layers. A particular object of this invention is to apply the grid lines and bus bar metal contacts to the frontside of the wafer by using a focused plasma spraying apparatus. A further object of this invention is to eliminate the need to have substrates exposed to very high temperatures which tend to deteriorate the diffused junction of metal to silicon. It is a yet further object to provide improved conversion efficiencies of solar cells by having improved ohmic contacts and grid patterns, and by providing front side grid electrodes of greater aspect ratios of height to width. It is a still further object to achieve the application of metal on the diffused wafer surface as well as the back side by at a single deposition station in one pass, instead of using separate screen printing devices and production steps as is currently practiced.

Still other objectives and advantages of the present invention will become readily apparent to those skilled in this art from the detailed description and figures that follow, wherein we have shown and described the preferred embodiment of the invention, simply by way of the best mode of contemplated by us for carrying out this invention.

### BRIEF DESCRIPTION OF THE DRAWINGS

FIG. 1 is a diagrammatic planar view of the lighted side of a prior art multigrain silicon solar cell.

FIG. 2 is a diagrammatic cross section view of the solar cell of FIG. 1, showing the front and back side contacts.

FIG. 3 is a diagrammatic cross section view of a metal line printed on the lighted side of a solar cell using prior art techniques.

FIG. 4 is a diagrammatic cross section view of a metal line applied to the lighted side of a solar cell in accordance with the invention by using plasma spray techniques.

FIG. 5 is a diagrammatic cross section view of a solar cell silicon wafer held in a wafer carrier system in a metal deposition plasma spray station consisting of a top side focused nozzle array.

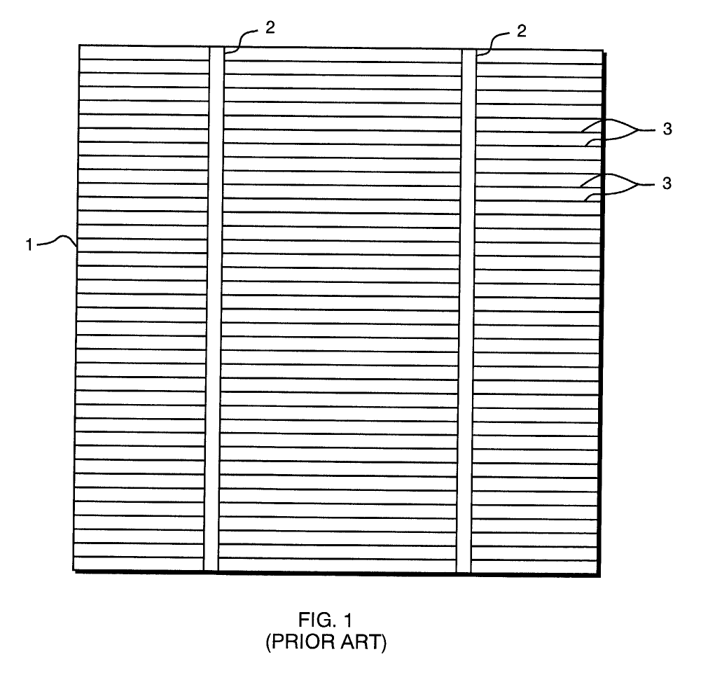

### DESCRIPTION OF THE PREFERRED EMBODIMENT

The invention relates to a method and apparatus for the application to solar cell wafers of frontside grid lines and bus lines and backside contact layers, using plasma spray techniques for all metal deposition. The invention is not restrictive to the type of pattern nor the metal that can be used for making the contacts. The choice of the metal will be dependent on the semiconductor used and the type and doping concentration on the faces. As an illustration for the preferred embodiment of the invention, silicon, which is the most commonly used semiconductor for terrestrial solar cells, will be used as a reference material for the core wafer. The metals for the frontside grid lines and the backside contact layer for a p-type doped silicon wafer may be may silver and aluminum, respectively. Conversely, the metals for the frontside gridlines and the backside contact layer for an n-type doped silicon wafer may be silver and nickel, respectively. The metals may be formulated as compounds with, for example, some silicon content for transition.

The frontside antireflection coating is generally applied before the metal contacts are applied. There are some processes in which the manufacturers prefer to lay the metal down first and then put on the antireflection coating. In the instant invention, we prefer the anti-reflection coating to be applied first, as a preliminary step, and then the metal grid lines and bus bar applied by the plasma spray technique of the invention. The p-n junction where the photovoltaic effect takes place is very close to the surface of the semiconductor wafer, only about 0.2 micrometers deep. If the spray particle energy is too high, the impact can degrade the junction and the photovoltaic effect. The sprayed metal powder will penetrate the thin reflective layer, which is about 700-800 Å, and make a good contact with the semiconductor core. The antireflection coating also absorbs some of the energy of the sprayed particles, softening the initial impact on the wafer surface.

The process used for metal deposition is the plasma spray technique, which is widely used for spray coating of metal, ceramic and polymer materials. While metalization and ohmic contact formation on solar cells using plasma spray technique have already been reported, the manner of application of metal grid lines along or in combination with other metal contacts on one or both sides of the wafer is the focus of the invention. The plasma spray system with frontside focused nozzle array and backside nozzle array is capable of emitting multiple jets of different metal powders that can deposit on select areas of the wafer, within a diameter or line with as small as about 50-100 microns and a depth of 30 to 50 microns.

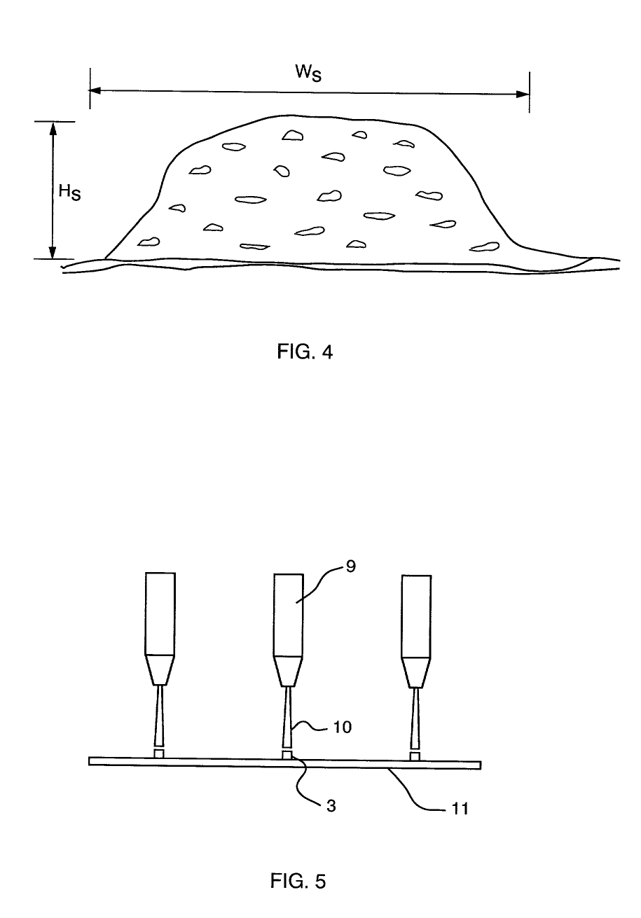

The materials for the spray deposition can be any of most of the metals used for electrodes on solar cells. The metals selected for use in accordance with the invention must be available in powder form and sprayable in such a multi-nozzle system. The preferred powder size is about less than 10 μm diameter. Referring to FIG. 4, there is shown in cross section a metal deposit on the frontside of a wafer as a grid line, that was applied by plasma spraying. The width Wₚ is in the range of 50 to 100 microns. The height Hₚ is in the range of 30 to 50 microns.

Comparing the FIG. 4 grid line of the focused plasma spray to the FIG. 3 grid line of the prior art screen printed solar cell, at the same line width of 100 microns, it is apparent that the focused plasma spray line has at least twice the aspect ratio and cross section area of the screen print line. The significantly greater cross section area and aspect ratio of the focused plasma spray line results in its conductivity being notably better than that of the screen-printed grid lines. The greater conductivity of plasma sprayed grid lines results in a higher collection efficiency of the solar cell.

Referring now to FIG. 5, metalization of the contact grid lines of about 100 microns and less in width on the front surface of the solar cell is achieved by configuring a top side plasma gun with an array of focused spray nozzles 9, configured closely adjacent to wafer 11 at about one to two millimeters distance; the nozzles being equally spaced for applying uniformly spaced grid pattern lines 3. The plasma streams are focused by the small jets of plasma nozzles 9, without using masks, such that the deposition area diameter of each nozzle is about the desired width of grid lines 3, in the range of 50 to 100 microns.

Two axis motion for applying the grid lines running in two dimensions is provided in the preferred embodiment. The topside nozzle array is laterally movable across the wafer carrier system path, while the wafer carrier is adjustably movable along its path beneath the nozzle array. Other arrangements providing the necessary two axis relative motion as between the nozzle array and the wafer, such as a fixed nozzle array and a two axis motion wafer platen or a fixed wafer station and two axis motion of the nozzle array, are within the scope of the invention.

Still referring to the single deposition station of FIG. 5, the metalization on the backside of the solar cell is carried out simultaneously with that on the frontside by using a plasma spray station assembly consisting of a back side nozzle or nozzles (not shown) in combination with the front side focused nozzle array. Wafers 11 are sequenced through the deposition station on a moving band or belt type wafer carrier system which grasps the edges of the wafer, leaving the front and back sides exposed for deposition. A conventional plasma spray torch nozzle or nozzles with a larger jet size for the backside deposition, and spray depositing the desired back contact layer at the same time as the front side grid lines are being applied.

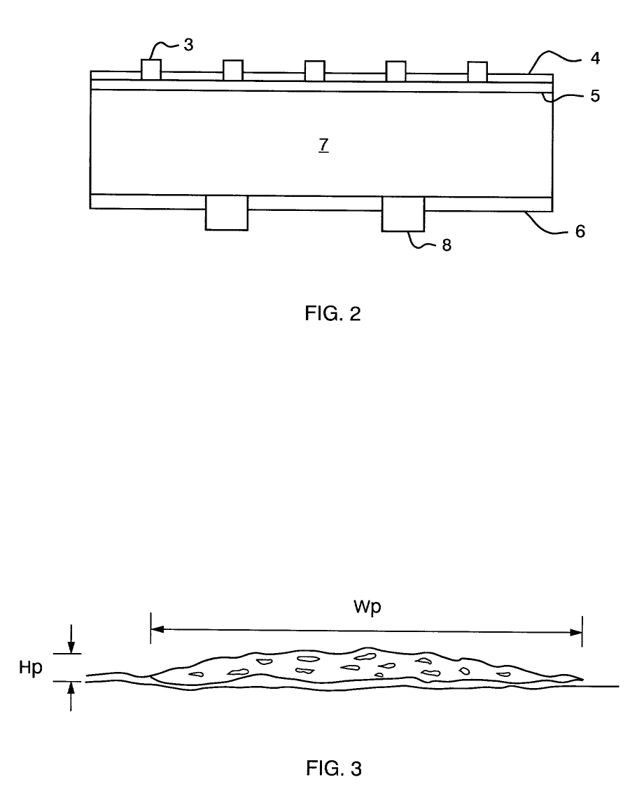

If an alternate metal contact pad is needed for leads, the equivalent contacts to the silver solder pads 8 of FIG. 2 are applied by a separate backside nozzle or multiple nozzles spraying the alternate metal powder, controlled to place the desired number of suitably sized pads of the alternate metal in the correct location and directly upon the primary backside contact layer. The solder pad nozzles can be configured within the contact layer nozzle array, or independently deployed immediately after the full contact layer is applied, so that all deposition is conducted at the same station.

In the prior art of screen printing contacts on solar cells, at least three machines are required to make all the contacts. This increases the floor space in the manufacturing area. Also, the screen printing process requires the subsequent high temperature operation, in the order of 800 degrees centigrade, for the drying of the metal paste and for penetration of the contact metal into the junction layer of the solar cell. This is normally not desirable in the manufacturing of the solar cell, especially after the diffusion step. With the method and apparatus of the present invention, only one apparatus and a one-step deposition process are needed to produce the equivalent result.

Yet another advantage of the invention is that there is no restriction to the metals that can be used so long as they can be reduced to and sprayed as a fine powder. The silk screening methods of the prior art used material that is very expensive. The cost of the paste used for the screen printing process is 75% of the cost of production of the solar cell. The relatively low cost of metal powder is a significant contributor to lower production costs of the invention.

Other examples within the scope of the invention include a method for the application of metal contacts on a solar cell wafer which includes the step of depositing a metal grid and bus bar pattern on the frontside of a silicon wafer by the focused plasma spraying of a first metal power, such as silver or a silver compound. There may be the additional preliminary steps of using a deposition station for the depositing operation and a wafer carrier system for holding the wafer, where advancing the wafer carrier system introduces the wafer into the deposition station for the metalizing operation. The deposition station may have a frontside array of focused plasma spray nozzles, where the frontside array and the wafer carrier system are configured for controlled two axis relative motion in closely adjacent parallel planes so that the grid lines can be traced onto the wafer in the desired pattern.

There may be included the further step of depositing a full metal contact layer on the back side of the wafer by plasma spraying a second metal powder while the wafer is still in the deposition station. There may be the additional step of depositing at least one metal contact pad on the full metal layer by plasma spraying a third metal powder such as silver or a silver compound, while the wafer is in the deposition station. In the case of the wafer being p-type doped silicon, the first metal powder may be silver or a silver compound, and the second metal powder may be aluminum or an aluminum compound. In the case of the wafer being n-type doped silicon, the second metal powder may be nickel or a compound containing nickel. The deposition station may have respective backside nozzle arrays for depositing the full metal contact layer and depositing the at least one metal contact pad. Also, the silicon wafer may have been pre-coated with an anti-reflection layer in advance of the metalizing process, so that the gridlines and bus bar are applied on and through the anti-reflective layer as previously explained.

Another example of the invention is a method for the application of metal contacts on a solar cell wafer, including the steps of placing a wafer in a wafer carrier system connected to a plasma spray deposition station, advancing the wafer carrier system so as to introduce the wafer into the deposition station, depositing a metal grid and bus bar pattern on the front side of the wafer by the focused plasma spraying of a first metal power while the wafer is in said deposition station, depositing a full metal contact layer on the back side of the wafer by plasma spraying a second metal powder while the wafer is in the deposition station. If the wafer is a p-type doped silicon wafer, the first metal powder may be silver or a silver compound, and the second metal powder may be aluminum or an aluminum compound. And if the wafer is n-type doped silicon, the second metal powder may be nickel or a nickel compound. There may also be the additional step of depositing at least one metal contact pad on the full metal layer by plasma spraying a third metal powder while the wafer is in said deposition station.

There are also devices within the scope of the invention, an example of which is a plasma spray deposition station for applying a grid line and bus bar pattern on a solar cell wafer consisting of a wafer carrier system for holding a wafer such that the frontside of the wafer is exposed for deposition, and a front side focused plasma spray nozzle array for depositing of a first metal power on the wafer, where the nozzle array and the wafer carrier system are configured for controlled two axis relative motion in closely adjacent parallel planes.

Another example of a device of the invention is a plasma spray deposition station for applying metal contacts on a solar cell wafer consisting of a wafer carrier system for holding a wafer edgewise such that the frontside and backside of said wafer are exposed for deposition, and a front side focused plasma spray nozzle array for depositing of a first metal power in a grid line and bus bar pattern on the frontside of the wafer, where the nozzle array and said wafer carrier system configured for controlled two axis relative motion in closely adjacent parallel planes, and a backside contact layer nozzle array for depositing of a second metal powder as a full metal contact layer on the backside of the wafer. There may also be a backside contact pad nozzle array for depositing of a third metal powder as at least one contact pad on the full metal contact layer on the backside of the wafer. The wafer carrier system may further include means for holding multiple wafers and sequentially advancing one wafer at a time into the deposition station, as in a production line process.

Other and various embodiments within the scope of the claims that follow will be readily apparent to those skilled in the art from the preceding description, examples and figures provided.

Among the claims are:

1. A method for the application of metal contacts on a solar cell wafer, comprising the step:
depositing a metal grid and bus bar pattern on the frontside of said silicon wafer by the focused plasma spraying of a first metal power.

2. A method according to claim 1, comprising the preliminary steps of
using a deposition station for said depositing and a wafer carrier system for holding said wafer, and
advancing said wafer carrier system so as to introduce said wafer into said deposition station.

3. A method according to claim 2, said deposition station comprising a frontside array of focused plasma spray nozzles, said frontside array and said wafer carrier system configured for controlled two axis relative motion in closely adjacent parallel planes.

4. A method according to claim 3, said wafer being p-type doped silicon, said first metal powder comprising silver.

5. A method according to claim 3, comprising the further step of
depositing a full metal contact layer on the back side of said wafer by plasma spraying a second metal powder while said wafer is in said deposition station.

6. A method according to claim 5, comprising the further step of
depositing at least one metal contact pad on said full metal layer by plasma spraying a third metal powder while said wafer is in said deposition station.

7. A method according to claim 5, said wafer being p-type doped silicon, said first metal powder comprising silver, said second metal powder comprising aluminum.

8. A method according to claim 5, said wafer being n-type doped silicon, said second metal powder comprising nickel.

9. A method according to claim 6, said silicon wafer being a p-type doped silicon wafer, said first metal powder comprising silver, said second metal powder comprising aluminum, said third metal powder comprising silver.

10. A method according to claim 6, said deposition station comprising respective backside nozzle arrays for said depositing a full metal contact layer and said depositing at least one metal contact pad.

11. A method according to claim 1, said frontside of said silicon wafer having been pre-coated with an anti-reflection layer.

12. A method for the application of metal contacts on a solar cell wafer, comprising the steps:
placing a wafer in a wafer carrier system connected to a plasma spray deposition station,
advancing said wafer carrier system so as to introduce said wafer into said deposition station,
depositing a metal grid and bus bar pattern on the front side of said wafer by the focused plasma spraying of a first metal power while said wafer is in said deposition station,
depositing a full metal contact layer on the back side of said wafer by plasma spraying a second metal powder while said wafer is in said deposition station.

13. A method according to claim 12, said wafer being a p-type doped silicon wafer, said first metal powder comprising silver, said second metal powder comprising aluminum.

14. A method according to claim 12, said wafer being n-type doped silicon, said second metal powder comprising nickel.

15. A method according to claim 12, comprising the further step of
depositing at least one metal contact pad on said full metal layer by plasma spraying a third metal powder while said wafer is in said deposition station.

16. A method according to claim 15, said silicon wafer being p-type doped silicon, said first metal powder comprising silver, said second metal powder comprising aluminum, said third metal powder comprising silver.

17. A method according to claim 12, said frontside of said silicon wafer having been pre-coated with an anti-reflection layer.

18. A plasma spray deposition station for applying a grid line and bus bar pattern on a solar cell wafer comprising:
a wafer carrier system for holding a wafer such that the frontside of said wafer is exposed for deposition, and
a front side focused plasma spray nozzle array for depositing of a first metal power on said wafer, said nozzle array and said wafer carrier system configured for controlled two axis relative motion in closely adjacent parallel planes.

19. A plasma spray deposition station according to claim 18, said wafer being p-type doped silicon, said first metal powder comprising silver.

20. A plasma spray deposition station for applying metal contacts on a solar cell wafer comprising:
a wafer carrier system for holding a wafer edgewise such that the frontside and backside of said wafer are exposed for deposition, and
a front side focused plasma spray nozzle array for depositing of a first metal power in a grid line and bus bar pattern on said frontside of said wafer, said nozzle array and said wafer carrier system configured for controlled two axis relative motion in closely adjacent parallel planes, and
a backside contact layer nozzle array for depositing of a second metal powder as a full metal contact layer on said backside of said wafer.

21. A plasma spray deposition station according to claim 20, said wafer being p-type doped silicon, and said first metal powder comprising silver, said second metal powder comprising aluminum.

22. A plasma spray deposition station according to claim 20, said wafer being n-type doped silicon, sand second metal power comprising a nickel compound.

23. A plasma spray deposition station according to claim 20, further comprising
a backside contact pad nozzle array for depositing of a third metal powder as at least one contact pad on said full metal contact layer on said backside of said wafer.

24. A plasma spray deposition station according to claim 23, said wafer being p-type doped silicon, said first metal powder comprising silver, said second metal powder comprising aluminum, said third metal powder comprising silver.

25. A plasma spray deposition station according to claim 20, said wafer carrier system further comprising means for holding multiple said wafers and sequentially advancing one said wafer at a time into said deposition station.
